(19) United States
(12) Patent Application Publication
(10) Pub. No.: US 2017/0339847 A1
(43) Pub. Date: Nov. 30, 2017

(54) PLANT CULTIVATION APPARATUS

(71) Applicant: Ming-Tsun Lin, Hsinchu County (TW)

(72) Inventor: Ming-Tsun Lin, Hsinchu County (TW)

(21) Appl. No.: 15/163,881

(22) Filed: May 25, 2016

(51) Int. Cl. A01G 9/24

(52) U.S. Cl. CPC A01G 9/246

(57) ABSTRACT

The invention discloses a plant cultivation apparatus comprising a plurality of partitioning spaces, each partitioning space intervally disposed with an isolation net, two ends of each partitioning space respectively disposed with an opening, a rack body respectively disposed inside each partitioning space to place plantings; a working region disposed at one end of the plurality of partitioning spaces, the working region comprising a plurality of ducted fans, each ducted fan respectively and correspondingly located above each partitioning space to supply and conduct airstream to another end of the partitioning space; and a water curtain component disposed at another end of the plurality of partitioning spaces to receive airstream supplied by the ducted fan and conducting it to the opening of each partitioning space so inject airstream into an inside of each partitioning space.

### BACKGROUND OF THE INVENTION

### 1. Field of the Invention

The invention relates to a plant cultivation apparatus, and more particularly to a plant cultivation apparatus having isolation effect to prevent cross-contamination of insect pest and to split airstream outputted by ducted fans in order to improve air ventilation rate.

### 2. Description of the Related Art

Currently, green houses can protect plants from being affected by overheat or undercooling and can further prevent plants from being threatened by dust storm and snowstorm and avoids invasion of mosquitos. Some non-cultivated lands become arable lands through the control of beam and temperature in green houses.

A manner of conventionally cultivating plants in a green house is shown in FIG. 1:

However, many plantings are simultaneously placed in the green house 1, and a plurality of ducted fans 3 is disposed in the green house 1 to enable air flow in the green house 1 to achieve ventilation required for plants. However, the manner of normally cultivating plants in the green house has many shortcomings as the following: 1. Plantings are not isolated and placed in sectioning. It is incapable of effectively restraining insect pest and easily causes cross-contamination. 2. Airstream outputted by the ducted fans flows in large spaces and is not split to easily disturb to each other and decreases ventilation rate such that hot and windless easily occurs in the green house 1, and air may not flow therein to further affect growing of plants.

### SUMMARY OF THE INVENTION

Therefore, upon the foregoing problem in prior art, it is an objective of the invention to provide a plant cultivation apparatus having isolation effect, capable of cross-contamination of insect pest and splitting airstream supplied by ducted fans in order to improve space ventilation rate.

According to the object of the invention, a plant cultivation apparatus is provided and comprises: a plurality of partitioning spaces, each partitioning space intervally disposed with an isolation net, two ends of each partitioning space respectively disposed with an opening, a rack body respectively disposed inside each partitioning space to place plantings; a working region disposed at one end of the plurality of partitioning spaces, the working region comprising a plurality of ducted fans, each ducted fan respectively and correspondingly located above each partitioning space to supply and conduct airstream to another end of the partitioning space; and a water curtain component disposed at another end of the plurality of partitioning spaces to receive airstream supplied by the ducted fan and conducting it to the opening of each partitioning space so inject airstream into an inside of each partitioning space.

Preferably, a height of the rack body is near a position of the opening.

Preferably, the inside of the working region communicates with the opening of each partitioning space, and airstream in each partitioning space circularly enters the inside of the working region through the opening and then outputs through each ducted fan.

Preferably, the water curtain component comprises a water curtain piece and a circulation tank, and the water curtain component is disposed at one end of the plurality of partitioning spaces and communicates with each opening, and the circulation tank is connected to the water curtain piece to supply circulation water to the water curtain piece to further regulate temperature of airstream entering into the water curtain piece.

Preferably, the isolation net is an airproof film.

Preferably, the isolation net is a sunshine board.

Preferably, a material of the isolation net is polyethylene, polycarbonate, polyethylene terephthalate, polymethyl methacrylate or polypropylene.

Preferably, a distance from a top of the partitioning space to the rack body is 90-100 cm.

Preferably, a distance from the rack body to ground is 70-120 cm.

Preferably, a distance from the top of the partitioning space to ground is 160-220 cm.

### BRIEF DESCRIPTION OF THE DRAWINGS

The detailed structure, operating principle and effects of the invention will now be described in more details hereinafter with reference to the accompanying drawings that show various embodiments of the invention as follows.

FIG. 1 is a schematic diagram of cultivating plants in a green house in prior art;

FIG. 2 is a first schematic diagram of a plant cultivation apparatus according to the embodiment;

FIG. 3 is a second schematic diagram of a plant cultivation apparatus according to the embodiment;

FIG. 4 is a third schematic diagram of a plant cultivation apparatus according to the embodiment;

FIG. 5 is a partial schematic diagram of a plant cultivation apparatus according to the embodiment.

### DETAILED DESCRIPTION OF THE PREFERRED EMBODIMENTS

The technical content of the present invention will become apparent by the detailed description of the following embodiments and the illustration of related drawings as follows.

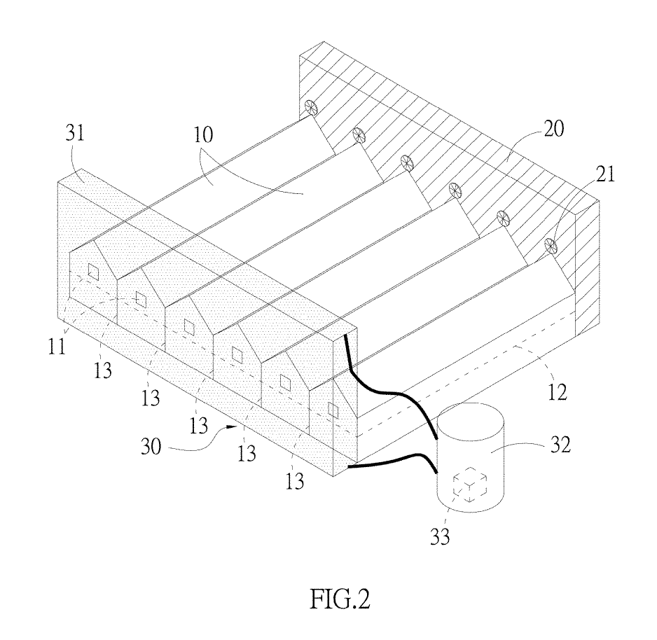

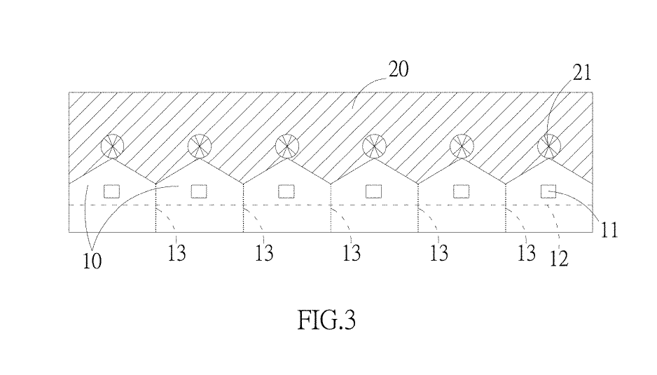

With reference to FIG. 2 to FIG. 4, a first schematic diagram, a second schematic diagram and a third schematic diagram for a plant cultivation apparatus according to the invention are respectively provided. The plant cultivation apparatus 100 comprises a plurality of partitioning spaces 10, a working region 2 and a water curtain component 30.

Two ends of each partitioning space 10 are respectively disposed with an opening 11. Each partitioning space 10 is disposed with an isolation net 13, and the inside of each partitioning space 10 is respectively disposed with a rack body 12 for placing plantings to downsize the partitioning space 10. A plurality of plantings 2 are sectioned and isolated by utilizing the plurality of partitioning spaces 10. Preferably, the height of the rack body 12 is designed as a position near the opening 11. Accordingly, when airstream enters the inside of the partitioning space 11, airstream can directly pass through plants cultivated on the plantings 2.

The working region 20 is disposed at one end of the plurality of partitioning spaces 10. The working region 20 comprises a plurality of ducted fans 21. Each ducted fan 21 is respectively and correspondingly configured onto each partitioning space 10 to output and conduct airstream to another end of the partitioning space 10. The water curtain component 30 is disposed at another end of the plurality of partitioning spaces 10 to receive airstream supplied by the ducted fan 21 and to conduct it to the opening 11 of each partitioning space 10 so that airstream is injected into the inside of each partitioning space 10, wherein the inside of the working region 20 communicates with the opening 11 of each partitioning space 10 such that airstream of each portioning space 10 circularly enters the inside of the working region 20 and then outputs through each ducted fan 21.

The water curtain component 30 further comprises a water curtain piece 31, a circulation tank 32 and a temperature controller 33. The circulation tank 30 is connected to the water curtain piece 21. The temperature controller 33 is disposed inside the circulation tank 32. The water curtain piece 31 is disposed at one end of the plurality of partitioning spaces 10 and communicates with each opening 11. The circulation tank 32 stores circulation water and supplies circulation water to the water curtain piece 31 to further regulate the temperature of airstream entering into the water curtain piece 31. The temperature controller 33, for example, can, but not limited to, be a refrigeration chip for controlling the temperature of circulation water so as to achieve efficacy of airstream temperature control.

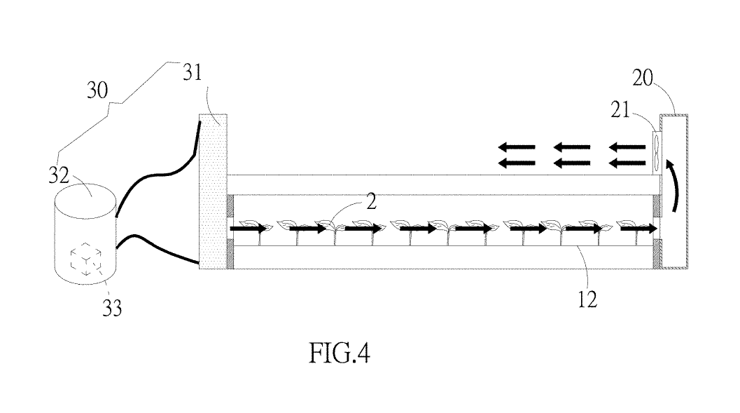

In detail, airstream outputted by the ducted fan 21 in the working region 20 of the plant cultivation apparatus according to the invention is shown in FIG. 4: airstream outputted by the ducted fan 21 flows through the water curtain piece 31 onto the partitioning space 10. The circulation water, which is from the circulation tank 32, outputted to the water curtain piece 31 will regulate temperature of airstream entering into the water curtain piece 31. Airstream, which has been performed with temperature regulation, enters into the partitioning space 10 from the opening 11 disposed at one end of the partitioning space 10. After airstream passes through the partitioning space 10, it enters into the working region 20 from the opening 11 disposed at another end of the partitioning space 10, and airstream then circularly outputs through the ducted fan 21.

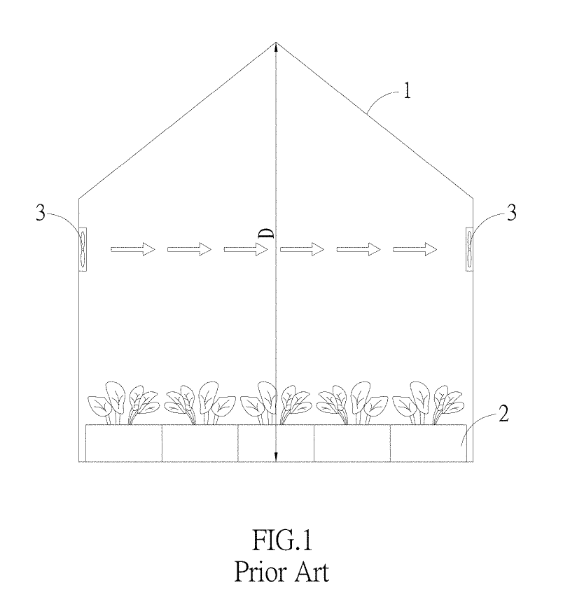

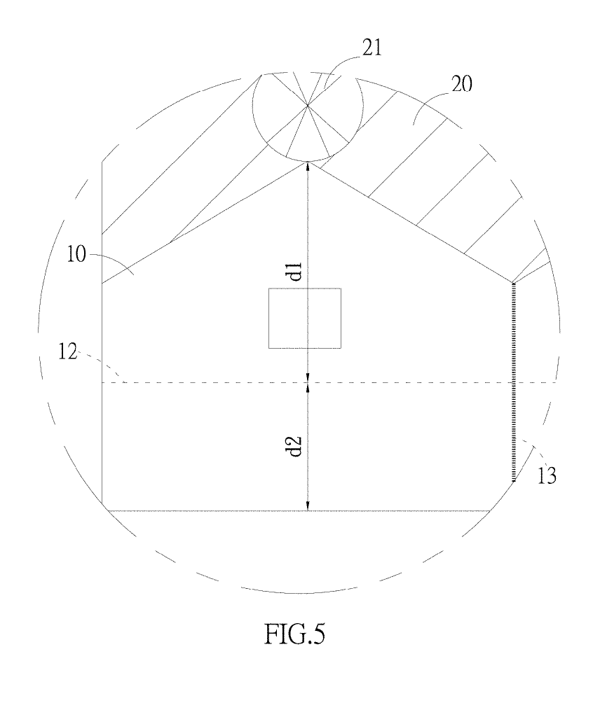

Moreover, with reference to FIG. 1 and FIG. 5, including a conventional planting region height D, a planting region d1, ground to the planting region height d1 and distance d2, the relation is D>(d1+d2). d1 distance is 90 to 100 cm, d2 distance is 70 to 120 cm, (d1+d2) distance is 160 to 220 cm. The number of ducted fans achieving air flow at 600 cubic meter and 1.8 times of air displacement based upon space at the same length and width but different heights is shown as the following table:

| | | Planting | | Air | Number of |
|---|---|---|---|---|---|
| Length | Width | region height | Air flow | displacement | ducted fan |
| 50 M | 50 M | 6 M | 600 m³ | 1.8 times | 45 |
| 50 M | 50 M | 0.9 M | 600 m³ | 1.8 times | 6.75 |

The plant cultivation apparatus according to the invention does not only achieve the condition required for conventional environment but also achieve the effect of saving costs.

Accordingly, the plant cultivation apparatus according to the invention respectively places plantings in each partitioning space to cultivate and splits airstream supplied by the ducted fan into each partitioning space, and supplied airstream is performed with temperature control through the water curtain component to obtain the following advantages:

1. Inspect pest can be effectively restrained, and cross-contamination of inspect pest can be prevented.

2. Air ventilation rate can be improved to have better heat dissipation efficiency.

3. Steam rising can be increased to facilitate growing plants.

4. It saves power and energy.

While the means of specific embodiments according to the present invention has been described by reference drawings, numerous modifications and variations could be made thereto by those skilled in the art without departing from the scope and spirit of the invention set forth in the claims. The modifications and variations should in a range limited by the specification of the present invention.

What is claimed is:

1. A plant cultivation apparatus comprising:
a plurality of partitioning spaces, each partitioning space intervally disposed with an isolation net, two ends of each partitioning space respectively disposed with an opening, a rack body respectively disposed inside each partitioning space to place plantings;
a working region disposed at one end of the plurality of partitioning spaces, the working region comprising a plurality of ducted fans, each ducted fan respectively and correspondingly located above each partitioning space to supply and conduct airstream to another end of the partitioning space; and
a water curtain component disposed at another end of the plurality of partitioning spaces to receive airstream supplied by the ducted fan and conducting it to the opening of each partitioning space so inject airstream into an inside of each partitioning space.

2. The plant cultivation apparatus of claim 1, wherein a height of the rack body is near a position of the opening.

3. The plant cultivation apparatus of claim 1, wherein the inside of the working region communicates with the opening of each partitioning space, and airstream in each partitioning space circularly enters the inside of the working region through the opening and then outputs through each ducted fan.

4. The plant cultivation apparatus of claim 1, wherein the water curtain component comprises a water curtain piece and a circulation tank, and the water curtain component is disposed at one end of the plurality of partitioning spaces and communicates with each opening, and the circulation tank is connected to the water curtain piece to supply circulation water to the water curtain piece to further regulate temperature of airstream entering into the water curtain piece.

5. The plant cultivation apparatus of claim 1, wherein the isolation net is an airproof film.

6. The plant cultivation apparatus of claim 1, wherein the isolation net is a sunshine board.

7. The plant cultivation apparatus of claim 1, wherein a material of the isolation net is polyethylene, polycarbonate, polyethylene terephthalate, polymethyl methacrylate or polypropylene.

8. The plant cultivation apparatus of claim 1, wherein a distance from a top of the partitioning space to the rack body is 90-100 cm.

9. The plant cultivation apparatus of claim 1, wherein a distance from the rack body to ground is 70-120 cm.

10. The plant cultivation apparatus of claim 1, wherein a distance from the top of the partitioning space to ground is 160-220 cm.
